(19) United States
(12) Patent Application Publication
(10) Pub. No.: US 2018/0324685 A1
(43) Pub. Date: Nov. 8, 2018

(54) INDICATING UPCOMING RANDOM ACCESS TRIGGER FRAME VIA FAST INITIAL LINK SETUP DISCOVERY FRAME

(71) Applicant: QUALCOMM Incorporated, San Diego, CA (US)

(72) Inventors: Abhishek Pramod Patil, San Diego, CA (US); Yan Zhou, San Diego, CA (US); George Cherian, San Diego, CA (US); Alfred Asterjadhi, San Diego, CA (US)

(21) Appl. No.: 15/951,932

(22) Filed: Apr. 12, 2018

Related U.S. Application Data
(60) Provisional application No. 62/502,497, filed on May 5, 2017.

(51) Int. Cl. H04W 48/16; H04W 8/00; H04W 74/08; H04W 76/11

(52) U.S. Cl. CPC H04W 48/16; H04W 8/005; H04W 24/10; H04W 76/11; H04W 74/08

(57) ABSTRACT

Systems and methods for wireless communication are provided. One aspect provides an apparatus for wireless communication comprising a processor, a transmitter, and a receiver. The processor may be configured to generate, at the apparatus, a discovery frame including an indication that the apparatus will transmit, during a discovery interval, a trigger frame assigning at least one resource unit for random access transmissions. The transmitter may be configured to transmit the discovery frame to one or more wireless stations, the discovery frame including the indication. The receiver may be configured to receive, in accordance with the at least one resource unit for random access transmissions, a multi-user transmission from at least one of the one or more wireless stations.

### CROSS REFERENCE TO RELATED APPLICATION(S)

This application claims the benefit of U.S. Provisional Application No. 62/502,497 titled “INDICATING UPCOMING RANDOM ACCESS TRIGGER FRAME VIA FAST INITIAL LINK SETUP DISCOVERY FRAME,” filed May 5, 2017. The content of this prior application is considered part of this application and is hereby incorporated by reference in its entirety.

### TECHNICAL FIELD

The present application relates generally to wireless communications, and more specifically to systems, methods, and devices for indicating an upcoming random access trigger frame via a fast initial link setup (FILS) discovery frame.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Wireless communication systems are widely deployed to provide various types of communication content such as voice and data. Typical wireless communication systems may be multiple-access systems capable of supporting communication with multiple users by sharing available system resources (e.g., bandwidth, transmit power). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), LTE Advanced (LTE-A), LTE Unlicensed (LTE-U), LTE Direct (LTE-D), License-Assisted Access (LAA), MuLTEfire, etc. These systems may be accessed by various types of user equipment (stations) adapted to facilitate wireless communications, where multiple stations share the available system resources (e.g., time, frequency, and power).

Wireless communications systems are widely deployed to provide various types of communication content such as voice, video, packet data, messaging, broadcast, and so on. Wi-Fi or WiFi (e.g., IEEE 802.11) is a technology that allows electronic devices to connect to a wireless local area network (WLAN). A WiFi network may include an access point (AP) that may communicate with one or more other electronic devices (e.g., computers, cellular phones, tablets, laptops, televisions, wireless devices, mobile devices, “smart” devices, etc.), which can be referred to as stations (STAs). The AP may be coupled to a network, such as the Internet, and may enable one or more STAs to communicate via the network or with other STAs coupled to the AP.

Wireless networks are often preferred when network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks advantageously facilitate user mobility and rapid field deployment when compared to fixed wired networks.

The prevalence of multiple wireless networks may cause interference, reduced throughput (for example, because each wireless network is operating in the same area and/or spectrum), and/or prevent certain devices from communicating. For the volume and complexity of information communicated wirelessly between multiple devices, the required overhead bandwidth continues to increase. Many wireless networks utilize carrier-sense multiple access with collision detection (CSMA/CD) to share a wireless medium. With CSMA/CD, before transmission of data on the wireless medium, a device may listen to the medium to determine whether another transmission is in progress. If the medium is idle, the device may attempt a transmission. The device may also listen to the medium during its transmission, so as to detect whether the data was successfully transmitted, or if perhaps a collision with a transmission of another device occurred. When a collision is detected, the device may wait for a period of time and then re-attempt the transmission. The use of CSMA/CD allows for a single device to utilize a particular channel (such as a spatial or frequency division multiplexing channel) of a wireless network.

Users continue to demand greater and greater capacity from their wireless networks. For example, video streaming over wireless networks is becoming more common. Video teleconferencing may also place additional capacity demands on wireless networks. In order to satisfy the bandwidth and capacity requirements users require, improvements in the ability of a wireless medium to carry larger and larger amounts of data are needed. Furthermore, the prevalence of multiple wireless networks or multiple wireless devices may cause interference, reduced throughput (for example, because each wireless network is operating in the same area and/or spectrum), and/or prevent certain devices from communicating. Thus, improved systems and methods for communicating, discovering other devices, and/or associating with other devices when wireless networks are densely populated and/or have interference are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of this invention provide advantages that include improved communications between access points and stations in a wireless network. Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present application provides an apparatus for wireless communication. The apparatus comprises a processor configured to generate, at the apparatus, a discovery frame including an indication that the apparatus will transmit, during a discovery interval, a trigger frame assigning at least one resource unit for random access transmissions. The apparatus further comprises a transmitter configured to transmit the discovery frame to one or more wireless stations, the discovery frame including the indication. The apparatus further comprises a receiver configured to receive, in accordance with the at least one resource unit for random access transmissions, a multi-user transmission from at least one of the one or more wireless stations.

Another aspect of the present application provides an apparatus for wireless communication. The apparatus comprises a receiver configured to receive, from an access point, a discovery frame. The apparatus further comprises a processor configured to decode the discovery frame to determine that the access point will transmit, during a discovery interval, a trigger frame assigning at least one resource unit for random access transmissions. The apparatus further comprises a transmitter configured to transmit, in accordance with the assigned at least one resource unit for random access transmissions, a multi-user transmission to the access point.

Another aspect of the present application provides a method for wireless communication. The method comprises generating, at an apparatus, a discovery frame including an indication that the apparatus will transmit, during a discovery interval, a trigger frame assigning at least one resource unit for random access transmissions. The method further comprises transmitting the discovery frame to one or more wireless stations, the discovery frame including the indication. The method further comprises receiving, in accordance with the at least one resource unit for random access transmissions, a multi-user transmission from at least one of the one or more wireless stations.

Another aspect of the present application provides a method for wireless communication. The method comprises receiving, from an access point, a discovery frame. The method further comprises decoding the discovery frame to determine that the access point will transmit, during a discovery interval, a trigger frame assigning at least one resource unit for random access transmissions. The method further comprises transmitting, in accordance with the assigned at least one resource unit for random access transmissions, a multi-user transmission to the access point.

Another aspect of the present application provides a non-transitory computer-readable medium comprising code that, when executed, causes a processor of an apparatus to generate, at the apparatus, a discovery frame including an indication that the apparatus will transmit, during a discovery interval, a trigger frame assigning at least one resource unit for random access transmissions. The code, when executed, further causes the processor of the apparatus to transmit the discovery frame to one or more wireless stations, the discovery frame including the indication. The code, when executed, further causes the processor of the apparatus to receive, in accordance with the at least one resource unit for random access transmissions, a multi-user transmission from at least one of the one or more wireless stations.

Another aspect of the present application provides a non-transitory computer-readable medium comprising code that, when executed, causes a processor of an apparatus to receive, from an access point, a discovery frame. The code, when executed, further causes the processor of the apparatus to decode the discovery frame to determine that the access point will transmit, during a discovery interval, a trigger frame assigning at least one resource unit for random access transmissions. The code, when executed, further causes the processor the apparatus to transmit, in accordance with the assigned at least one resource unit for random access transmissions, a multi-user transmission to the access point.

Yet another aspect of the present application provides an apparatus for wireless communication. The apparatus comprises a processor, in connection with a memory of the apparatus, configured to store, in the memory, a default value for a Random Access Parameter Set (RAPS). The processor, in connection with the memory, is further configured to perform a RAPS countdown in accordance with the default value. The apparatus further comprises a transmitter configured to transmit, in accordance with an assigned at least one resource unit for random access transmissions, a multi-user transmission to the access point.

### BRIEF DESCRIPTION OF THE DRAWINGS

FIG. 1 is a diagram that illustrates a wireless multiple-access multiple-input multiple-output (MIMO) system including access points (APs) and stations (STAs), in which aspects of the present disclosure can be employed.

FIG. 2 is a functional block diagram of a wireless device that can be employed within the wireless MIMO system of FIG. 1.

FIG. 3 is a diagram that illustrates another embodiment of the wireless MIMO system of FIG. 1, in which aspects of the present disclosure can be employed.

FIG. 4 is a timing diagram of messages transmitted from an access point, in accordance with an implementation.

FIG. 5 is an example message format of a trigger frame, in accordance with an implementation.

FIG. 6 is an example message format of a discovery frame, in accordance with an implementation.

FIG. 7 is another example message format of a discovery frame, in accordance with an implementation.

FIG. 8 is a flowchart of a method for wireless communication, in accordance with an implementation.

FIG. 9 is a flowchart of a method for wireless communication, in accordance with an exemplary embodiment.

### DETAILED DESCRIPTION

Various aspects of the novel systems, apparatuses, methods, and mediums are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc.

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

The word “exemplary” is used herein to mean “serving as an example, instance, or illustration.” Any implementation described herein as “exemplary’ is not necessarily to be construed as preferred or advantageous over other implementations. The following description is presented to enable any person skilled in the art to make and use the embodiments described herein. Details are set forth in the following description for purpose of explanation. It should be appreciated that one of ordinary skill in the art would realize that the embodiments may be practiced without the use of these specific details. In other instances, well known structures and processes are not elaborated in order not to obscure the description of the disclosed embodiments with unnecessary details. Thus, the present application is not intended to be limited by the implementations shown but is to be accorded with the widest scope consistent with the principles and features disclosed herein.

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some implementations, a WLAN includes various devices which access the wireless access network. For example, there may be: access points (“APs”) and stations (also referred to as clients, wireless stations, user equipment, UEs, and STAs, among other names). In general, an access point serves as a hub, a router, or a base station for the stations in the WLAN. A station may be a laptop computer, a personal digital assistant (PDA), a mobile phone, a smart device, a smart appliance, or any type of computer-based device that can access the WLAN. In an example, a station connects to an access point via a Wi-Fi (e.g., IEEE 802.11 protocol, such as 802.11ah, 802.11ai, 802.11ax, etc.) compliant wireless link to obtain general connectivity to the Internet, to one or more other stations and/or access points on the WLAN, or to other wide area access networks. In some implementations, a station may also be used as an access point.

Furthermore, an access point (“AP”) may comprise, be implemented as, or known as a NodeB, Radio Access network Controller (“RNC”), eNodeB (“eNB”), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology. Similarly, a station (“STA”) may also comprise, be implemented as, or known as a user terminal, an access terminal (“AT”), a subscriber station, a subscriber unit, a mobile station, a remote station, a remote terminal, a user agent, a user device, a user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a Node-B (Base-station), or any other suitable device that is configured to communicate via a wireless medium.

In some aspects, wireless signals may be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol may be used for Internet access, sensors, metering, smart grid networks, or other wireless applications. Advantageously, aspects of certain devices implementing this particular wireless protocol may consume less power than devices implementing other wireless protocols, may be used to transmit wireless signals across short distances, and/or may be able to transmit signals less likely to be blocked by objects, such as humans.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). The cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). The cdma2000 is described in documents from an organization named “3rd Generation Partnership Project 2” (3GPP2). These various radio technologies and standards are known in the art.

The disclosed techniques may also be applicable to technologies and the associated standards related to LTE-A, LTE-U, LTE-D, LTE, MuLTEfire, W-CDMA, TDMA, OFDMA, High Rate Packet Data (HRPD), Evolved High Rate Packet Data (eHRPD), Worldwide Interoperability for Microwave Access (WiMax), GSM, enhanced data rate for GSM evolution (EDGE), and so forth. MuLTEfire is an LTE-based technology that solely operates in unlicensed spectrum and does not require an “anchor” in licensed spectrum. Terminologies associated with different technologies can vary. LTE-D is a device-to-device technology that utilizes the licensed LTE spectrum and was released as part of 3GPP Release 12. LTE-D devices can communicate directly with other devices by sending a message in the network allocated slot and bandwidth. In some embodiments, depending on the technology considered, the station used in UMTS can sometimes be called a mobile station, a station, a user terminal, a subscriber unit, an access terminal, etc., to name just a few. Likewise, Node B used in UMTS can sometimes be called an evolved Node B (eNodeB or eNB), an access node, an access point, a base station (BS), HRPD base station (BTS), and so forth. It should be noted here that different terminologies apply to different technologies when applicable

The disclosed techniques may also be applicable to various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency-Division Multiple Access (OFDMA) systems, Single-Carrier Frequency-Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency-division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal. An access point may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Router, Radio Transceiver, Basic Service Set (“BSS”), Extended Service Set (“ESS”), Radio Base Station (“RBS”), or some other terminology. A station (“STA”) may also comprise, be implemented as, or known as a user terminal (“UT”), an access terminal (“AT”), a subscriber station, a client, a wireless client, a wireless station, a subscriber unit, a mobile station, a remote station, a remote terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a smart device, a smart appliance, or any type of suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a smart device, a smart appliance, or any other suitable device that is configured to communicate via a wireless medium.

It is well-known that in certain types of wireless networks, wireless stations (or STAs) may contend for wireless medium access. For example, wireless stations may attempt to connect with, transmit to, receive from, or otherwise associate with an access point or another wireless device on the network. In a multiple-input multiple-output (MIMO) network, multiple wireless devices may transmit and receive multiple communications to and from one another at the same or similar times. Naturally, such wireless configurations can lead to wireless communication conflicts. For example, when multiple stations attempt to send a multi-user (MU) communication to an access point at the same time over the same bandwidth, the messages can collide and fail. Although transmission times are often short (e.g., on the order of microseconds to milliseconds), as the number of devices on the network increases, the likelihood of transmission interferences increases. Thus, when stations do not have sufficient mechanisms for avoiding conflicts or sufficient information regarding the wireless medium, the access point, other stations, etc., such stations may instead send a single-user (SU) communication to the access point. Systems may utilize the well-known ready-to-send (RTS) and clear-to-send (CTS) mechanism for wireless medium reservation over particular time periods to reduce network collisions and increase quality-of-service (QoS) for the network.

However, as the number of devices connected to networks increases, so too do the network interferences. Furthermore, as wireless devices increase in mobility (e.g., cellphones, laptops, etc.) and as access points approach ubiquity, it becomes increasingly important that wireless stations are capable of efficiently discovering and connecting to (e.g., associating with) access points in their vicinity. Wireless stations may attempt to communicate with access points for, for example, association, pre-association discovery, ranging, among other purposes, as one having ordinary skill in the art will appreciate. As one example, in a restaurant, a number of wireless stations (e.g., cellphones) may be already connected to an access point (e.g., a wireless router). The already connected wireless stations can also be referred to as “associated stations” or “associated clients.” Continuing with this example, a customer may walk into the restaurant with a wireless station that is not already connected to the access point (e.g., the customer's cellphone). In this context, the customer cellphone can be referred to as an “unassociated station” or an “unassociated client.” To discover the access point, the unassociated station may search for the access point via, for example, active scanning or passive scanning. For example, to discover the access point, the unassociated station may search for the access point via active scanning (e.g., while the unassociated station is in an “awake” state). For example, the unassociated station may actively scan for the access point by selecting a wireless channel, transmitting a probe request frame over the selected channel, waiting for a response or a lack of response, and connecting to the access point or choosing a different channel accordingly. Alternatively, the unassociated station may passively scan for the access point by selecting a channel and waiting on the channel until the access point transmits a beacon. As one having ordinary skill in the art will appreciate, depending on the number of other wireless stations, the quality of the network, the quality of the connection for the station, among many other factors, such procedures often waste one or both of power (e.g., battery power drain via active scanning) and time (e.g., via passive scanning). Thus, wireless devices can utilize various mechanisms to alleviate such issues.

For example, wireless devices may utilize discovery frames (also referred to herein as “DFs,” or in the singular, “DF”) during discovery and/or association processes. Discovery frames can be of varying types and formats, for example, an access point can transmit a Fast Initial Link Setup (FILS) Discovery Frame (also referred to herein as “FILS DF,” “FD frame,” etc.) to aid beacon discovery for wireless stations. An FD frame can have a relatively short length and provide basic information about the access point to wireless stations to aid their discovery of the associated basic service set (BSS). The FD frame can also include an indication regarding when stations can expect a subsequent beacon, e.g., via a target beacon transmit time (TBTT). In this way, the wireless stations can use the TBTT to find the subsequent beacon, which can provide the wireless stations with additional information about the access point, e.g., association information.

As another example, wireless devices may utilize trigger frames (also referred to herein as “TFs,” or in the singular, “TF”) during discovery and/or association processes. As a simplified example, an access point can transmit a trigger frame so as to occupy a certain bandwidth, for example, 160 MHz. The trigger frame may include an Association Identifier (AID) for one or more stations receiving the trigger frame, which can facilitate the receiving stations to inform the access point that the stations intend to transmit communications to the access point. To help reduce collisions thereto, the access point can divide the bandwidth into portions and assign the portions to one or more stations, e.g., according to one or more AIDs. Such assignments can be indicated in the trigger frame. In some aspects, the trigger frame can also indicate a duration that the bandwidth portion is available for the one or more stations.

Furthermore, an access point may transmit a trigger frame that can include information about resource units (RUs). The use of RUs in wireless networking can facilitate scheduled access for stations to connect with access points, particularly in dense wireless networks. As one example, an access point may assign one or more RUs to one or more stations, via the trigger frame, and then the corresponding stations can utilize the RUs to transmit uplink traffic to the access point. As a simplified example, an access point may assign a small subchannel to a particular wireless station and indicate the assignment in the trigger frame. The trigger frame may also include a duration that the small subchannel is available for transmission by the particular wireless station. The access point may be capable of assigning up to a certain number of RUs (e.g., eight). The access point may assign one or more of the RUs to a particular type of wireless station, as opposed to an individual wireless station. As an example, the access point may assign one or more of the RUs for one or more of associated wireless stations, unassociated wireless stations, both associated and unassociated wireless stations, wireless stations connecting via random access, etc. To continue with the example above, the customer's unassociated wireless station may attempt to discover, connect to, and/or associate with the access point via random access. Thus, in this example, the unassociated wireless station may contend for access over an RU assigned for random access, which may also be referred to herein as a “random access RU,” “random access resource unit,” “random access unit,” “RA-RU,” etc.

In some cases, although a wireless station may be capable of connecting to the access point via a random access resource unit, no such random access resource units may be available, or other wireless stations may utilize the, often limited, random access resource units that are available. In some instances, multiple wireless stations may contend for the same random access resource unit at the same time, which can result in collisions and/or failed transmissions. Thus, wireless devices may utilize a Random Access Parameter Set (RAPS), which one having ordinary skill in the art will appreciate is based on orthogonal frequency division multiple access (OFDMA). An access point may include RAPS information in a trigger frame such that multiple stations seeking to connect to the access point via random access can each connect while reducing the chance for collisions. As a simplified example, the access point may include a RAPS countdown value in the trigger frame, which may cause the stations to randomly select a value between zero and the countdown value. Thereafter, the stations may reduce the value each time the access point sends particular subsequent communications, until the value reaches zero. Once the value reaches zero, that particular station may attempt to connect to the access point via random access. In some instances, wireless stations just entering the network may not be aware of the initial or current RAPS information (e.g., the countdown value), which can increase collisions. Thus, in some instances, wireless stations may be configured to utilize a default countdown value, which can further facilitate reducing possible collisions. In some aspects, the RAPS countdown value may also be referred to herein as “an OBO count value,” “a backoff value,” “a countdown value,” “a count,” etc. In some aspects, the countdown value may not be associated with RAPS and may simply be referred to as an orthogonal frequency division multiple access (OFDMA) backoff value.

Even still, wireless stations (e.g., the customer's unassociated wireless station described in the example above) may have difficulty discovering and/or associating with access points during times of high interference, high traffic, particular timing scenarios, among other conditions. For example, wireless stations that do not have sufficient information regarding the network and/or the access point (e.g., a waking wireless station, a new unassociated wireless station, etc.) may not know whether any random access resource units are available. Thus, such wireless stations may resort to active or passive scanning to discover the access point, which can waste resources, as described above. Thus, systems and methods are described herein that further facilitate discovery of and/or association with access points.

Although the embodiments described below convey aspects of the present disclosure from the perspective of a single access point and/or a single wireless station, the aspects can be implemented and/or performed on any number of, or all of, the stations or access points on a network.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). The cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). The cdma2000 is described in documents from an organization named “3rd Generation Partnership Project 2” (3GPP2). These various radio technologies and standards are known in the art.

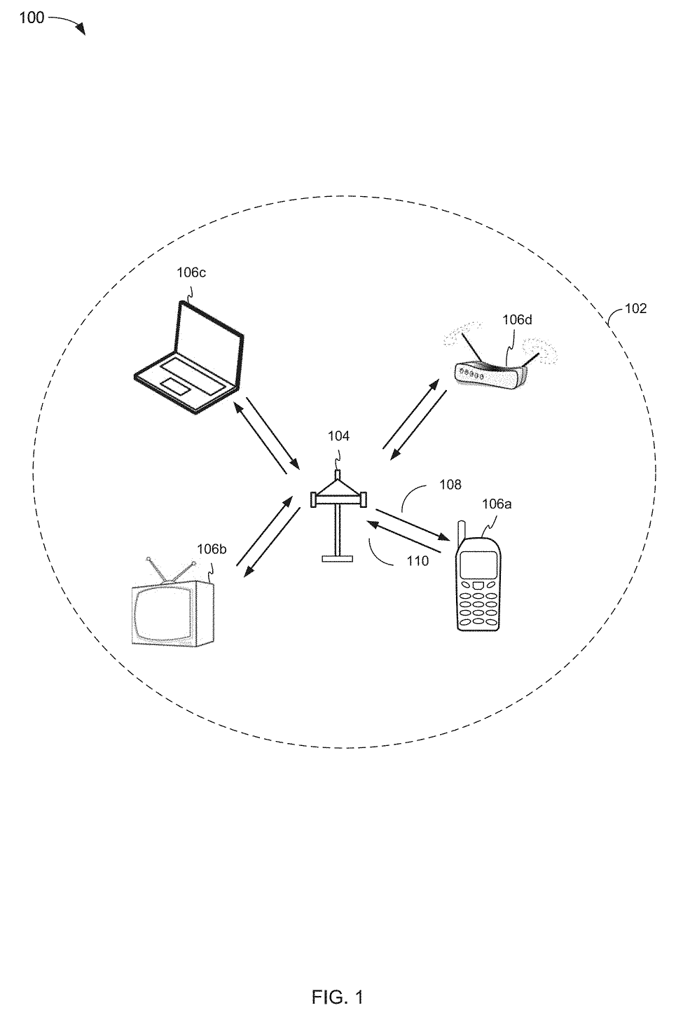

FIG. 1 is a diagram that illustrates a wireless multiple-access multiple-input multiple-output (MIMO) system 100 including access points (APs) and stations (STAs), in which aspects of the present disclosure can be employed. The MIMO system 100 may operate pursuant to a wireless standard, for example, an 802.11ax standard. For simplicity, only one AP 104 is shown in FIG. 1. The AP 104 may also communicate with additional STAs (not pictured). The STAs may also individually or collectively operate as an AP, or vice versa.

As described above, the AP 104 may communicate with the STAs 106a-d (also referred to herein collectively as “the STAs 106” or individually as “the STA 106”) and may also be referred to as a base station or using some other terminology. Also, as described above, a STA 106 may be fixed or mobile and may also be referred to as a user terminal, a mobile station, a wireless device, or using some other terminology. The AP 104 may communicate with one or more STAs 106 at any given moment on the downlink or uplink. The downlink (i.e., forward link) is the communication link from the AP 104 to the STAs 106, and the uplink (i.e., reverse link) is the communication link from the STAs 106 to the AP 104. A STA 106 may also communicate peer-to-peer with another STA 106 (not pictured).

A variety of processes and methods can be used for transmissions in the MIMO system 100 between the AP 104 and the STAs 106. For example, signals can be sent and received between the AP 104 and the STAs 106 in accordance with OFDM/OFDMA techniques. If this is the case, the MIMO system 100 can be referred to as an OFDM/OFDMA system. As another example, signals can be sent and received between the AP 104 and the STAs 106 in accordance with code division multiple access (CDMA) techniques. If this is the case, the MIMO system 100 can be referred to as a CDMA system.

A communication link that facilitates transmission from the AP 104 to one or more of the STAs 106 can be referred to as a downlink 108, and a communication link that facilitates transmission from one or more of the STAs 106 to the AP 104 can be referred to as an uplink 110. Alternatively, a downlink 108 can be referred to as a forward link or a forward channel, and an uplink 110 can be referred to as a reverse link or a reverse channel. The AP 104 may connect to one or more channels so as to communicate with the STAs 106.

The AP 104 may act as a base station and provide wireless communication coverage in a basic service area 102. The AP 104 along with the STAs 106 associated with the AP 104 and that use the AP 104 for communication can be referred to as a basic service set (BSS). It should be noted that the MIMO system 100 may not have a central AP, but rather may function as a peer-to-peer network between the STAs 106. Accordingly, the functions of the AP 104 described herein may alternatively be performed by one or more of the STAs 106.

A STA 106 can associate with the AP 104 in order to send communications to and/or receive communications from the AP 104. In one aspect, information for associating is included in a broadcast by the AP 104 (e.g., in a beacon, in a frame, etc.; not pictured). To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe, a request, a probe response frame, a probe request, etc., to the AP 104. In some aspects, the AP 104 may use backhaul services, for example, to communicate with a larger network, such as the Internet or a public switched telephone network (PSTN).

The AP 104 may perform some or all of the operations described herein to improve discovery and association procedures with respect to the MIMO system 100. The functionality of some implementations of the AP 104 is described in greater detail below. Alternatively, or in addition, the STAs 106 may perform some or all of the operations described herein to improve discovery and association procedures with respect to the MIMO system 100.

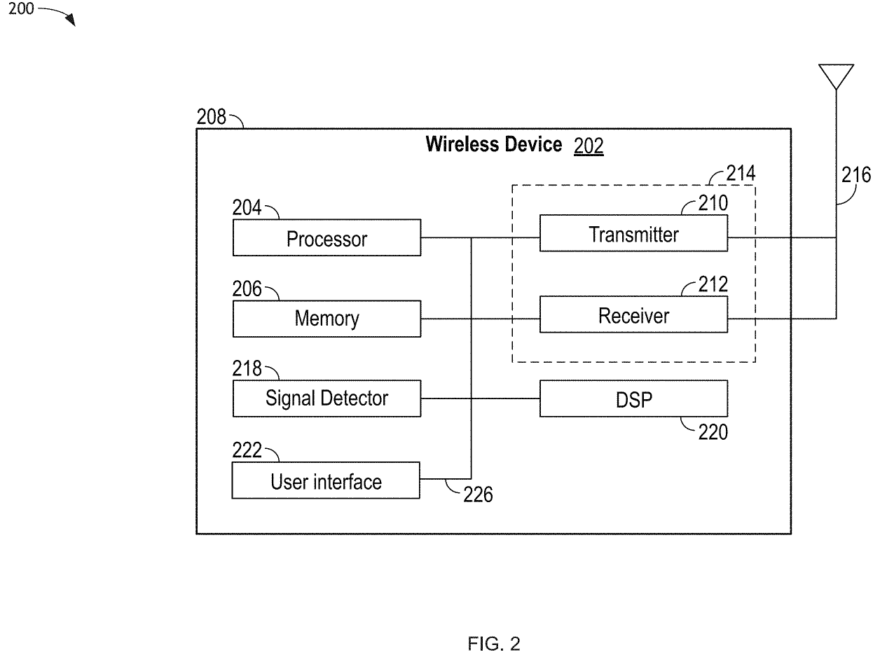

FIG. 2 is a functional block diagram 200 of a wireless device 202 that can be employed within the wireless MIMO system 100 of FIG. 1. FIG. 2 illustrates various components that may be utilized in the wireless device 202. The wireless device 202 is an example of a device that may be configured to implement the various methods described herein. The wireless device 202 may implement an AP 104 or a STA 106. With respect to the description of FIG. 2 herein, some of the item numbers may refer to the so-numbered aspects described above in connection with FIG. 1. For example, the wireless device 202 may comprise one of the stations 106 and/or the access point 104.

The wireless device 202 may include an electronic hardware processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 may perform logical and arithmetic operations based on program instructions stored within the memory 206. The instructions in the memory 206 may be executable to implement the methods described herein.

The processor 204 may comprise or be a component of a processing system implemented with one or more electronic hardware processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. A single or a plurality of transceiver antennas 216 may be attached to the housing 208 and electrically coupled to the transceiver 214. The wireless device 202 may also include (not shown) multiple transmitters, multiple receivers, and multiple transceivers.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. In some aspects, the wireless device may also include one or more of a user interface component 222, cellular modem (not pictured), and a wireless lan (WLAN) modem (not pictured). The cellular modem may provide for communication using cellular technologies, such as CDMA, GPRS, GSM, UTMS, or other cellular networking technology and/or may provide for communications using one or more WiFi technologies, such as any of the IEEE 802.11 protocol standards.

The various components of the wireless device 202 may be coupled together by a bus system 226, which may include a power bus, a control signal bus, and a status signal bus in addition to a data bus.

Although a number of separate components are illustrated in FIG. 2, those of skill in the art will recognize that one or more of these components may be implemented not only with respect to the functionality described above, but also to implement the functionality described above with respect to other components. For example, the processor 204 may be used to implement not only the functionality described above with respect to the processor 204, but also to implement the functionality described above with respect to the signal detector 218 and/or the digital signal processor 220. Each of the components illustrated in FIG. 2 may be implemented using a plurality of separate elements. As noted above, the wireless device 202 may comprise the access point 104 or the station 106 and may be used to transmit and/or receive communications over licensed or unlicensed spectrums.

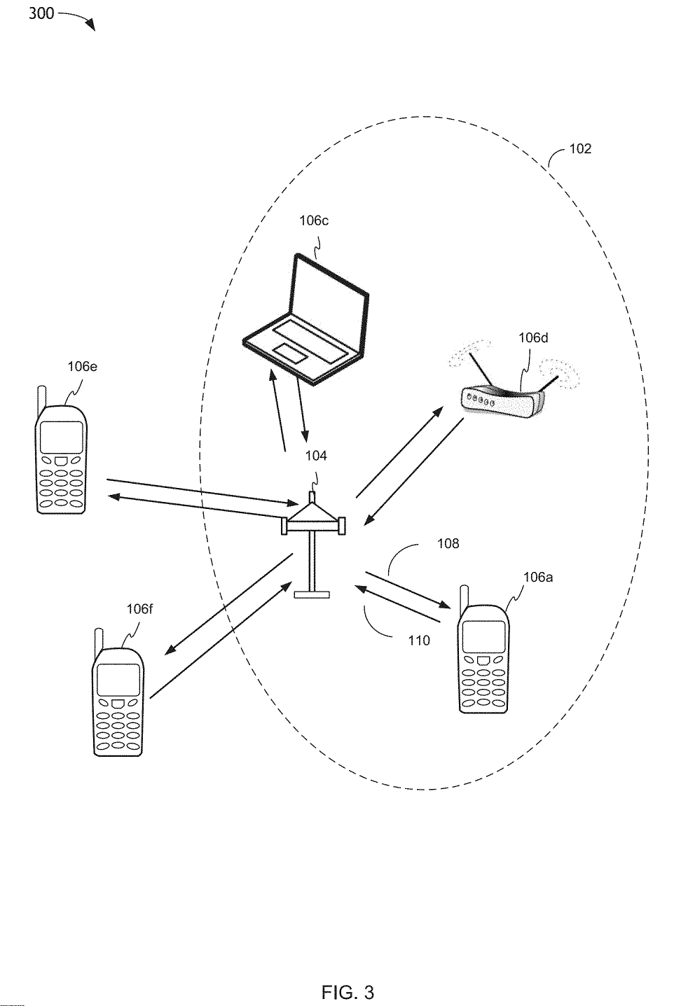

FIG. 3 is a diagram that illustrates another embodiment 300 of the wireless MIMO system 100 of FIG. 1, in which aspects of the present disclosure can be employed. With respect to the description of FIG. 3 herein, some of the item numbers may refer to the so-numbered aspects described above in connection with one or more of FIG. 1 and FIG. 2. The diagram illustrates one non-limiting example embodiment of the MIMO system 100. FIG. 3 shows that stations 106a, 106c and 106d are within the basic service set (BSS) 102 of the AP 104, and in this example, are considered as “associated” with the AP 104. Stations 106e and 106f, in this example, are considered as “unassociated” with the AP 104. As described herein, a first wireless device (e.g., an access point) may be considered as unassociated with a second wireless device (e.g., a station) if the first wireless device is a member of, or has, a first basic service set (BSS) and the second wireless device is a member of, or has, a second basic service set (BSS) that is different from the first basic service set. As one having ordinary skill in the art will appreciate, in this non-limiting example, the second wireless device (e.g., which may be a non-AP station) may not be associated with any access point (AP). Thus, in this example, the second BSS may be referred to as “null” or “empty,” and is thus “different” from the first BSS.

Continuing with the examples described above, one or more of the wireless stations 106 may contend for wireless medium access, association with, connection to, etc., with the AP 104. In certain scenarios, one of the stations 106 may not have sufficient mechanisms or information regarding the wireless medium, the AP 104, other stations 106, etc. Thus, such stations may inefficiently send a single-user (SU) communication to the AP 104, as described above. Further continuing the example above, in a restaurant, the stations 106c, 106d, and 106a may be already connected to the AP 104 and may be referred to as “associated stations” or “associated clients.” A customer may walk into the restaurant with, for example, the station 106f (e.g., the customer's cellphone), which may not be already connected to the AP 104. As described above, in this context, the station 106f can be referred to as an “unassociated station” or an “unassociated client.” For the reasons described above, in some instances, the station 106f (as well as any of the other stations 106) may have difficulty discovering and/or associating with the AP 104, for example, during times of high interference, high traffic, particular timing scenarios, among other conditions. Systems and methods are described herein that improve discovery of and/or association with an access point on the network (e.g., the AP 104) for one or more of the stations on the network (e.g., the station 106f).

The AP 104 may assign one or more RUs to one or more of the stations 106, enabling the one or more stations to utilize the RUs to transmit uplink traffic to the access point. The AP 104 may facilitate uplink communication to it by transmitting a frame defining how resource units (RUs) may be used, for example, during a transmission opportunity (TXOP). In some aspects, a resource unit (RU) may be a smallest sub-channel within a particular 802.11 channel (e.g., 20, 40, 80, or 160 MHz wide). Resource units may include any number of tones. For example, in some aspects, a resource unit may include 26 tones, 52 tones, 106 tones, or any number of tones. Each resource unit may define a number of subcarriers for use in a transmission. The AP 104 may also indicate a duration that one or more of the RUs are available for transmission by the corresponding stations.

The RUs described herein can be of any number or type of category and format, including, but not limited to: uplink communications to an access point (e.g., the AP 104) that are part of a multi-user transmission during a transmission opportunity of the AP 104; random access transmissions by associated devices (e.g., the station 106a) to the AP 104; random access transmissions by unassociated devices (e.g., the station 106f) to the AP 104; transmissions by devices (either associated with or unassociated with the AP 104) to other devices that are not the AP 104 (e.g., between the station 106f and the station 106a), etc. The random access transmissions may be performed according to a random access procedure, which can mitigate collisions between devices attempting to transmit messages to the AP 104 during a transmission opportunity using RUs, as will be further described below. In some aspects, the AP 104 may also indicate one or more resource units that should not be utilized for transmissions by any devices, whether those transmissions are destined for the AP 104 or destined for another device.

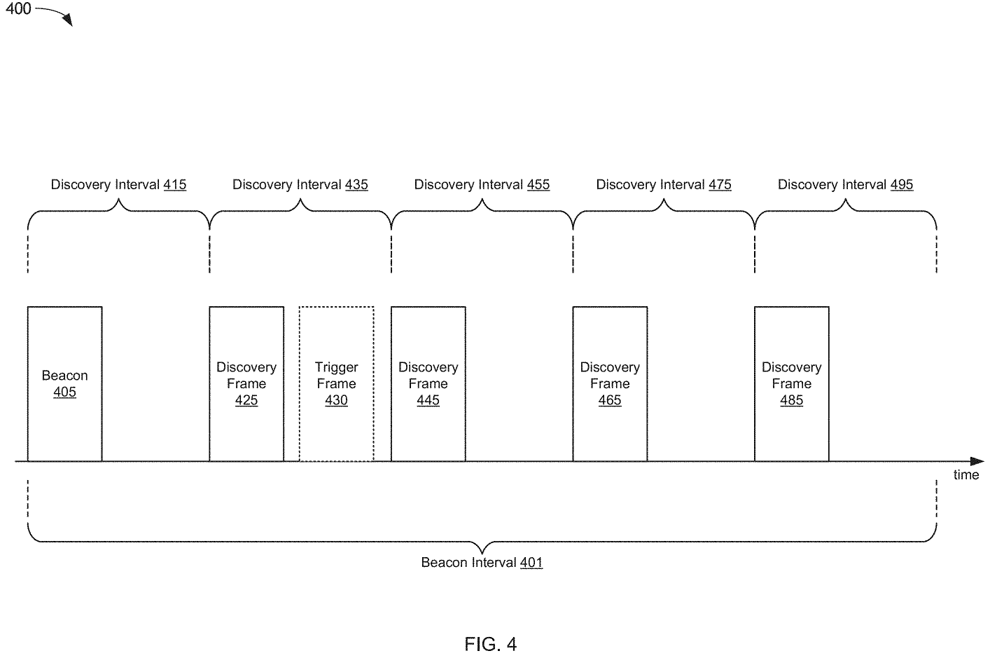

The transmissions discussed above may occur based on timing information included in, for example, a trigger frame. In some aspects, certain of the transmissions may be initiated a predetermined time after transmission of a trigger frame, such as, for example, a short inter-frame space (SIFS) time. Others of the transmissions may utilize a pre-transmission procedure before the transmissions occur. Others may utilize a random access procedure, which may reduce a risk of collision that could occur if two different devices attempt transmissions using the same resource units. In some aspects, the random access procedure may be based on a number of resource units available. Certain of the communications may also include a back off procedure during a transmission opportunity. In accordance with embodiments described herein, and as further described below in connection with FIG. 4, to facilitate a multi-user uplink communication, the AP 104 may transmit one or more trigger frames (not pictured) indicating parameters for one or more of the stations 106 to utilize during the multi-user uplink transmission, for example, according to one or more of the RU categories and formats described above (e.g., random access RUs). The AP 104 may also transmit a discovery frame (not pictured) to one or more of the stations 106, including an indication that the AP 104 will transmit, during an immediately following discovery interval, a trigger frame, which may assign at least one resource unit, e.g., for random access transmissions.

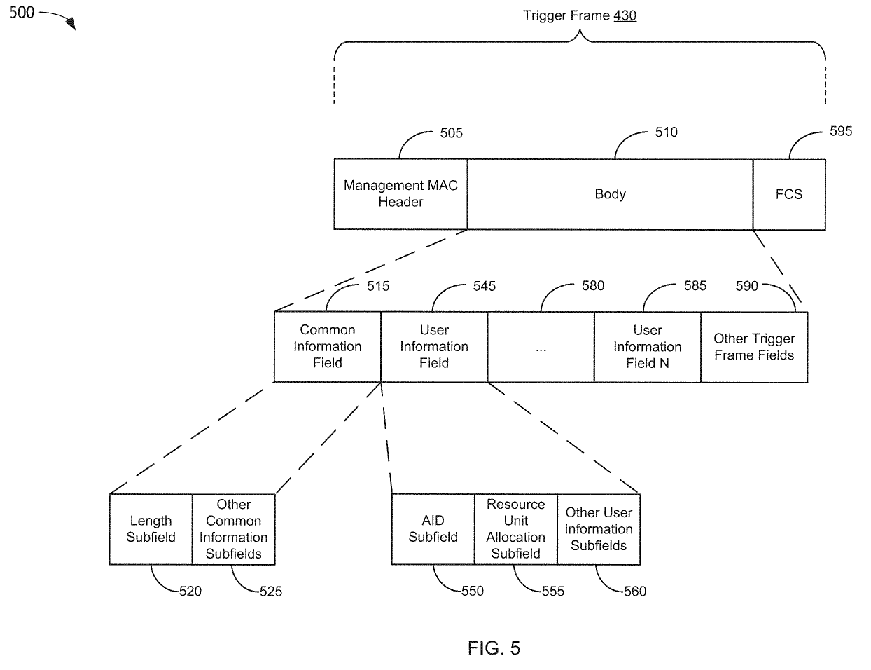

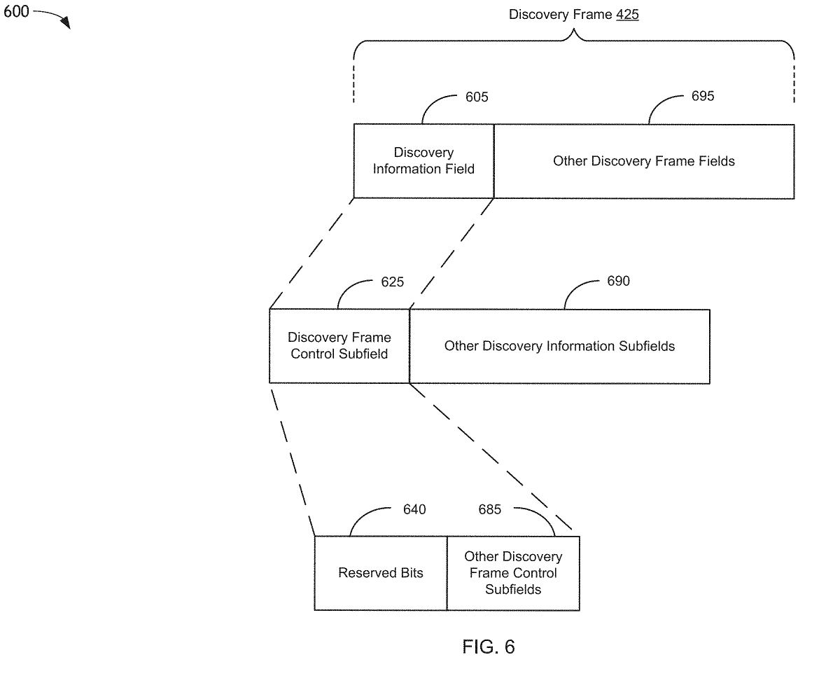

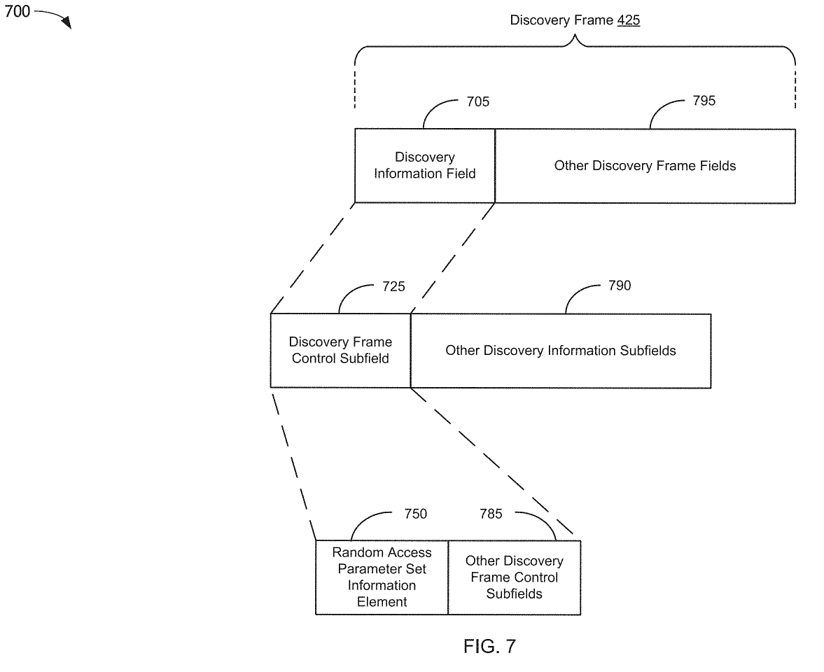

FIG. 4 is a timing diagram 400 of messages transmitted (e.g., a discovery frame 425 and a trigger frame 430) from an access point (e.g., the AP 104), in accordance with an implementation. With respect to the description of FIG. 4 herein, some of the item numbers may refer to the so-numbered aspects described above in connection with one or more of FIGS. 1-3. Example embodiments of the trigger frame 430 are described in connection with FIG. 5 below, and further details regarding example embodiments of the discovery frame 425 are described in connection with FIG. 6 and FIG. 7 below. One having ordinary skill in the art will understand that the communication ranges are not drawn to-scale and are for illustrative purposes only.

In general, the AP 104 can transmit a beacon 405, which can begin a beacon interval 401 for wireless stations (e.g., the stations 106) in the vicinity. In one example, the beacon interval 401 can be 100 milliseconds (ms) long. In an aspect, transmitting the beacon 405 can further begin a discovery interval 415, during which, one or more wireless stations (e.g., one or more of the stations 106) may have opportunities to discover the AP 104. As will be appreciated by one having ordinary skill in the art, a “discovery interval” (e.g., the discovery interval 415) can be an interval between consecutive frames. As one example, the interval between consecutive discovery frames can be a discovery interval. As another example, the interval between a discovery frame and a beacon can be a discovery interval. As a non-limiting example, a beacon interval (e.g., the beacon interval 401) may be 100 milliseconds (ms), and an FD frame (e.g., the discovery frame 425) may occur every 20 ms. In this example, the time intervals between each frame (including the beacon) can each be referred to as a discovery interval (e.g., the discovery intervals 415, 435, 455, 475, and 495). One having ordinary skill in the art will further appreciate that one or more other time periods may be defined (not pictured) during the beacon interval 401. As one having ordinary skill in the art will appreciate, the one or more other time periods may completely overlap with, may partially overlap with, or may fall completely within a discovery interval (e.g., the discovery interval 435). For example, one or more target wait time (TWT) service periods (TWT-SPs) may be defined (not pictured) during the beacon interval 401. Thus, a frame (e.g., the trigger frame 430) described herein as being transmitted during a discovery interval (e.g., the discovery interval 435) may be transmitted during (“within”) or not during (“outside”) one or more other time periods, for example, a TWT-SP (not pictured). Referring back to FIG. 4, the discovery interval (e.g., the discovery interval 435) can be shorter than the beacon interval 401. In one example, the Beacon interval 401 can be 100 ms, while the discovery interval 415 can be 20 ms. As illustrated, and as described above, the AP 104 can send a discovery frame (e.g., the discovery frame 425), which can begin a subsequent discovery interval (e.g., a discovery interval 435), which can be the same duration as the discovery interval 415. This may continue (e.g., via discovery frames 445, 465, and 485, starting discovery intervals 455, 475, and 495, respectively), until the end of the beacon interval 401. The timing, quantity, and durations of the intervals and frames shown in FIG. 4 represent one simplified example for illustrative purposes.

For illustrative purposes, the following descriptions include examples regarding discovery frames with primary reference to the discovery frame 425. However, such examples can also be implemented via one or more of the discovery frame 445, the discovery frame 465, and the discovery frame 485. Similarly, the following descriptions include examples regarding trigger frames with primary reference to the trigger frame 430. However, such examples can also be implemented via one or more additional trigger frames (not pictured), for example, trigger frames occurring at different times (not pictured). It should be further understood that the beacon interval 401 represents one illustrative example of a single beacon interval in association with the AP 104 and/or the STAs 106 and that additional beacons, and their respective beacon intervals, may occur before and/or after the illustrated beacon interval 401, during which the embodiments described herein may be further implemented.

As described above, the AP 104 may transmit the discovery frame 425 to the STAs 106 to facilitate discovery and/or association processes. The discovery frame 425 can be of varying types and formats, for example, the discovery frame 425 can be a Fast Initial Link Setup (FILS) Discovery Frame (also referred to herein as “FILS DF,” “FD frame,” etc.). Thus, as described above, the discovery frame 425 can provide information about the AP 104 to STAs 106 to aid their discovery of the associated basic service set (BSS). The discovery frame 425 can also include an indication regarding when stations can expect a subsequent beacon, e.g., via a target beacon transmit time (TBTT).

As further described above, the AP 104 may transmit the trigger frame 430 (also referred to herein as “TFs,” or in the singular, “TF”) during discovery and/or association processes. The trigger frame 430 may include information about resource units (RUs), as further described above. As one example, an unassociated wireless station (e.g., the station 106f) may attempt to discover, connect to, and/or associate with the AP 104 via random access. Thus, in this example, the station 106f may contend for access over an RU that the AP 104 assigns for random access, which may also be referred to herein as a “random access RU,” “random access resource unit,” “random access unit,” “RA-RU,” etc.

For example, the trigger frame 430 may indicate (e.g., or assign), among other parameters, resource units (RUs) to be utilized by one or more of the STAs 106, for example, when participating in a multi-user transmission. Because one or more of the STAs 106 may transmit data to the AP 104 at the same time, the STAs 106 may utilize different subsets of the resource units (e.g. frequency bands or subcarriers) to encode their respective transmissions. These subcarriers may be identified via resource units, with each resource unit identifying a particular non-overlapping portion of a frequency spectrum (via identified subcarriers). In some aspects, the trigger frame 430 may be a request to send frame (RTS), request to transmit (RTX), clear to send (CTS), or a clear to transmit (CTX), or dedicated trigger message. In some aspects, the AP 104 may reserve one or more of the RUs for random access, which may involve a random access procedure determining a number of resource units available for random access transmission. The trigger frame 430 may further indicate certain resource units that are not available for use by devices for transmission, or that are available for transmissions when one or more criteria are met, as further described below.

As also described above, the AP 104 may also include RAPS information in the trigger frame 430, such that multiple stations (e.g., the station 106f and the station 106e) seeking to connect to the AP 104 via random access can each connect while reducing the chance for collisions. In some instances, one or both of the station 106f and the station 106e just entering the network may not be aware of the initial or current RAPS information (e.g., the countdown value), which can increase collisions. Thus, in some instances, the STAs 106 may be configured to utilize a default countdown value, which can be stored, for example, at the STAs 106.

In accordance with one or more embodiments described herein, the AP 104 may generate, at the AP 104, the discovery frame 425. The discovery frame 425 can include an indication (as described in connection with FIG. 6 and FIG. 7) that the AP 104 will transmit, during a discovery interval (e.g., the discovery interval 435), the trigger frame 430. As another example, the AP 104 can indicate, via the discovery frame 425, that at least one trigger frame (e.g., trigger frame 430) will be transmitted during the interval between the current discovery frame (e.g., the discovery frame 425) and the next beacon (not pictured) and/or the next discovery frame (e.g., the discovery frame 445).

The discovery frame 425 can further indicate that the trigger frame 430 will assign at least one resource unit for random access transmissions, as described in connection with FIG. 5). Thereafter, as illustrated in FIG. 4, the AP 104 can transmit the discovery frame 425 (e.g., to one or more of the STAs 106), and then transmit the trigger frame 430 during the discovery interval 435. Having received the discovery frame 425 including the indication regarding the upcoming trigger frame 430, receiving STAs (e.g., the STA 106f) may forego wasting resources on passive scanning, active scanning, waiting for another beacon or discovery frame, etc. Instead, such STAs may wait for the trigger frame 430 (as informed by the discovery frame 425) to transmit a multi-user transmission for facilitating discovery and/or association (e.g., a probe request frame or a probe response frame, for example) to the AP 104.

FIG. 5 is an example message format 500 of a trigger frame (e.g., the trigger frame 430 described in connection with FIG. 4), in accordance with an implementation. With respect to the description of FIG. 5 herein, some of the item numbers may refer to the so-numbered aspects described above in connection with one or more of FIGS. 1-4. It should be understood that a trigger frame for use in the implementations described herein can include any combination of types and numbers of packets, fields, data, etc. and that the illustrated example in FIG. 5 is one exemplary embodiment thereto. Each of the fields and subfields illustrated may not necessarily be fields or subfields, depending on the type of data transfer. For example, a given field or subfield may include a plurality of fields, subfields, or one or more packets, headers, values, flags, etc., or any combination thereof.

As illustrated, the trigger frame 430 can include one or more portions, for example, a management media access control (MAC) header 505, a body 510, and a frame check sequence (FCS) 595. The management MAC header 505 may indicate the message is a trigger frame via one or more fields having one or more predetermined values. The trigger frame 430 may include other portions (not pictured). The body 510 may include one or more fields, for example, a common information field 515, a user information field 545, additional user information fields 580, a final user information field N 585, and any number and variety (not pictured) of other trigger frame fields 590. The common information field 515 may include one or more subfields, for example, a length subfield 520 and any number and variety (not pictured) of other common information subfields 525. The user information field 545 may include one or more subfields, for example, an AID subfield 550, a resource unit allocation subfield 555, and any number and variety (not pictured) of other user information fields 560.

In accordance with one or more embodiments described herein, the AP 104 may generate the discovery frame 425 to include an indication (as described in connection with FIG. 6 and FIG. 7) that the AP 104 will transmit, during a discovery interval (e.g., the discovery interval 435), the trigger frame 430. As described above, the discovery frame 425 can further indicate that the trigger frame 430 will assign at least one resource unit for random access transmissions.

Furthermore, the AP 104 can generate the trigger frame 430 to indicate a duration of the assignment for the at least one resource unit for random access transmissions. For example, the AP 104 can generate the trigger frame 430 to include the duration using one or more bits of the length subfield 520. In another example, the AP 104 can generate the trigger frame 430 to include the duration using one or more bits of the other common information subfields 525.

The AP 104 can generate the trigger frame 430 to indicate that the assignment of the at least one resource unit for random access transmissions is reserved for unassociated wireless stations. For example, the AP 104 can generate the trigger frame 430 to include the indication using one or more bits of the AID subfield 550. In another example, the AP 104 can generate the trigger frame 430 to include the duration using one or more bits of the resource unit allocation subfield 555 and/or the other user information subfields 560. For example, the AID subfield 550 may comprise an AID12 subfield including, for example, 12 bits. The AP 104 may indicate an identity of a particular wireless station that one or more RUs are reserved for using one or more bits of the AID subfield 550. In an aspect, the identity may be unique for each station.

In an aspect, a STA (e.g., the STA 106f) may be the intended receiver of a User Info field (e.g., the user information field 545) in a trigger frame (e.g., the trigger frame 430). As one example, AID12 of a subfield of the user information field 545 may be set to be equal to the 12 least-weighted bits (LSBs) of the AID of the STA 106. In this case, the STA 106f may be configured to ignore the remainder of the fields in the user information field 545 in the trigger frame 430. A STA (e.g., the STA 106f) that is the intended receiver of the user information field 545 in the trigger frame 430 may further be configured to not contend for a random access RU that is indicated by a trigger frame contained in the same Physical Layer Convergence Protocol (PLCP) protocol data unit (PPDU) and to not decrement its countdown (e.g., OBO) counter.

Furthermore, a STA (e.g., the STA 106f) may be configured to not consider a particular RU for random access for transmission or for decrementing its OBO counter if the STA 106f does not have the capability of transmitting a frame (e.g., a probe response frame) as indicated by one or more subfields of the user information field 545 corresponding to that random access RU. Furthermore, the STA 106f may be configured to not contend for random access RU or decrement its OBO counter if the STA 106f does not have pending frames (e.g., a probe response frame) for an AP (e.g., the AP 104).

In an aspect, a high-efficiency (HE) STA (e.g., the STA 106a) that is associated with an AP (e.g., the AP 104) may have an OBO counter that is not larger than the number of RUs assigned to the AID12 subfield value 0 in a trigger frame (e.g., the trigger frame 430) from the AP 104. In this case, then the STA 106a may be configured to decrement its OBO counter to zero. Otherwise, the STA 106a may be configured to decrement its OBO counter by the number of RUs assigned to AID12 subfield value 0 in a trigger frame (e.g., the trigger frame 430).

In another aspect, a high-efficiency (HE) STA (e.g., the STA 106f) that is unassociated with an AP (e.g., the AP 104) may have an OBO counter that is not larger than the number of RUs assigned to AID12 subfield value 2045 in a trigger frame (e.g., the trigger frame 430) from the AP 104 that the AP 104 intends to transmit. In this case, the AP 106f may be configured to decrement its OBO counter to zero. Otherwise, the STA 106f may be configured to decrement its OBO counter by a value equal to the number of RUs assigned to AID12 subfield value 2045 in a trigger frame (e.g., the trigger frame 430).

Furthermore, the AP 104 can generate the trigger frame 430 to define one or more criteria that the one or more wireless stations must satisfy to qualify for random access priority in association with the assigned at least one resource unit (“RU”) for random access (“RA”) transmissions (e.g., at least one “RA-RU”). For example, the AP 104 can indicate the criteria using one or more bits of the AID subfield 550 to indicate that the assigned at least one resource unit for random access transmissions is reserved for unassociated wireless stations that satisfy the one or more criteria. For example, the AID subfield 550 may comprise an AID12 subfield including, for example, 12 bits. The AP 104 may indicate that one or more RUs are reserved for associated STAs, e.g., by setting AID equal to zero. The AP 104 may indicate that one or more RUs are reserved for unassociated STAs, e.g., by setting AID (e.g., AID12) equal to 2045. Furthermore, a particular type of unassociated station that has a poor connection with the AP 104 (e.g., being far away from the AP 104) may be considered as “uplink limited.” Thus, continuing the example above, the one or more criteria may include a Received Signal Strength Indicator (RSSI) being below an RSSI threshold.

As another example, in accordance with an embodiment, one or more of the receiving STAs (e.g., the STA 106a) may not satisfy certain criteria indicated in, for example, one or more subfields of the trigger frame 430, as described above. For example, as described above, the AP 104 may specify, for example, an RSSI threshold criteria using one or more bits of the AID subfield 550 of the trigger frame 430. The AP 104 may further indicate, in the trigger frame 430, that the assigned at least one resource unit for random access transmissions is reserved for unassociated wireless stations that satisfy the one or more criteria. If the STA 106a, in this example, which does not satisfy the criteria (e.g., because an RSSI of the STA 106a is above the RSSI threshold), then the STA 106a may be configured to refrain from decrementing an OFDMA backoff value associated with the at least one resource unit for random access transmissions that is reserved for unassociated wireless stations that satisfy the one or more criteria. In contrast, STAs that do satisfy the criteria (e.g., the STA 106f, for example, because an RSSI of the STA 106f is below the RSSI threshold) may be configured to decrement an OFDMA backoff value associated with the at least one resource unit for random access transmissions that is reserved for unassociated wireless stations that satisfy the one or more criteria.

Thus, the STA 106f, having a lower RSSI than the STA 106a, would be more likely to reach a zero countdown value than the STA 106f, and thus transmit a multi-user transmission to the AP 104 over the at least one resource unit for random access transmissions that is reserved for unassociated wireless stations that satisfy the one or more criteria. In this way, the AP 104 may receive a multi-user transmission in accordance with an orthogonal frequency division multiple access (OFDMA) backoff value, associated with the at least one of the one or more wireless stations (e.g., the STA 106f), being decremented only when the at least one of the one or more wireless stations (e.g., the STA 106f) satisfies each of the one or more criteria.

As another example, the AP 104 can indicate that trigger frame 430 will carry random access for particular stations, e.g., associated stations (e.g., the station 106a), unassociated stations (e.g., the station 106f), or both. In this way, the AP 104 may signal (e.g., via a combination of one or more bits in the discovery frame 425) whether the AP 104 intends to transmit at least one trigger frame (e.g., the trigger frame 430) with random access for certain stations, for example, unassociated stations, like the STA 106f. This can facilitate an unassociated station (e.g., the STA 106f) for discovery and/or association with the AP 104 over any such random access RU.

Thus, as illustrated in FIG. 4, after transmitting the discovery frame 425 (e.g., to one or more of the STAs 106), the AP 104 can transmit the trigger frame 430 during the discovery interval 435. Having received the discovery frame 425 including the indication regarding the upcoming trigger frame 430, receiving STAs (e.g., the STA 106f) may forego wasting resources on passive scanning, active scanning, waiting for another beacon or discovery frame, etc. Instead, such STAs may wait to receive the trigger frame 430 (as informed by the discovery frame 425) to transmit a multi-user transmission for facilitating discovery and/or association (e.g., a probe request) to the AP 104 over the associated RU.

FIG. 6 is an example message format 600 of a discovery frame (e.g., the discovery frame 425 described in connection with FIG. 4), in accordance with an implementation. In an embodiment, the discovery frame 425 can be a FILS discovery frame, as described above. With respect to the description of FIG. 6 herein, some of the item numbers may refer to the so-numbered aspects described above in connection with one or more of FIGS. 1-5. It should be understood that a discovery frame for use in the implementations described herein can include any combination of types and numbers of packets, fields, data, etc. and that the illustrated example in FIG. 6 is one exemplary embodiment thereto. Each of the fields and subfields illustrated may not necessarily be fields or subfields, depending on the type of data transfer. For example, a given field or subfield may include a plurality of fields, subfields, or one or more packets, headers, values, flags, etc., or any combination thereof.

As illustrated, the discovery frame 425 can include one or more fields, for example, a discovery information field 605 and any number and variety (not pictured) of other discovery frame fields 695. The discovery information field 605 may include one or more subfields, for example, a discovery frame control subfield 625 and any number and variety (not pictured) of other discovery information subfields 690. The discovery frame control subfield 625 may include one or more subfields, for example, subfields including or comprising of reserved bits 640 and any number and variety (not pictured) of other discovery frame control subfields 685 (e.g., a field of the discovery frame 425, an element of the discovery frame 425, etc.).

In accordance with one or more embodiments described herein, the AP 104 may generate the discovery frame 425 to include an indication that the AP 104 will transmit, during a discovery interval (e.g., the discovery interval 435), the trigger frame 430. For example, the AP 104 can generate the discovery frame 425 to include the indication using at least one of the one or more reserved bits 640.

The AP 104 may generate the discovery frame 425 to further indicate that the trigger frame 430 will assign at least one resource unit for random access transmissions. The AP 104 may further utilize a Random Access Parameter Set (RAPS), which, as described above, may allow receiving stations (e.g., unassociated stations) to have information regarding the RAPS without waiting for a subsequent beacon. The unassociated stations (e.g., the station 106f) may use a predefined RAPS default value, which can be stored, for example, at the STA 106f, upon receiving the discovery frame 425. In an aspect, the default RAPS value may be set as 8. In an aspect, the predefined RAPS default value may be defined in an 802.11 Standard.

One or more of the wireless devices (one or more of the STA 104 and the STAs 106) may be configured to store the predefined RAPS default value and be capable of setting the default RAPS value accordingly. The default value may comprise an orthogonal frequency division multiple access (OFDMA) backoff value, in one example. The AP 104 may subsequently receive, in accordance with the default value, a transmission from at least one of the one or more wireless stations (e.g., the STA 106f), as further described below.

As described above, if a STA (e.g., the STA 106f) receives a frame (e.g., the discovery frame 425) from the AP 104 that includes RAPS information, the STA 106f may select a countdown value (e.g., a RAPS countdown value) based on the RAPS information from the AP 104. In some instances, the STA 106f may only select the countdown value based on the RAPS information from the AP 104 if the STA 106f intends to transmit one or more frames to the AP 104. In an aspect, the STA 106f may receive multiple frames (e.g., multiple discovery frames) from the AP 104 and from another AP (not pictured). Each of the multiple frames may include RAPS information, and the RAPS information may be different from each of the APs. In this instance, the STA 106f may be configured to select a countdown value (e.g., a RAPS countdown value) based on the RAPS information from the AP of the APs that the STA 106f intends to communicate with. As described above, if the STA 106f does not receive a frame from an AP (e.g., the AP 104) including RAPS information, then the STA 106f may select a countdown value based on a default value, e.g., a predefined default value stored at the STA 106f.

Furthermore, if a station (e.g., the station 106f) begins a countdown (e.g., a RAPS countdown) in association with an access point (e.g., the AP 104) and subsequently switches to attempting to connect with a different access point (not pictured), then the station 106f may be configured to start the countdown over. In another aspect, if the station 106f attempts to connect with multiple access points, then the station 106f may maintain multiple RAPS countdown values, one for each of the access points.

As an example, a non-AP STA (e.g., the STA 106f) may re-initializes its OBO counter each time it communicates with a different AP. Thus, if there are three APs (e.g., AP1, AP2, and AP3) in the neighborhood, and if the STA 106f has learned the RAPS from the AP1, then the following may occur. The STA 106f may initialize its OBO based on AP1's RAPS when the STA 106f intends to communicate with AP1 via random access. The STA 106f may also initialize its OBO based on a default RAPS (e.g., stored at the STA 106f) when the STA 106f intends to communicate with AP2 via random access. Finally, the STA 106f may initialize its OBO based on the default RAPS when the STA 106f intends to communicate with AP3 via random access.

In an aspect, RAPS information can include one or more aspects, for example, an element ID, a length, an element ID extension, an orthogonal frequency division multiple access (OFDMA) contention window (OCW) range field, among other aspects. Furthermore, a field (e.g., an OCW range field) associated with the RAPS information can include one or more aspects, for example, a minimum OCW value, a maximum OCW value, and one or more reserved fields and/or bits.

For example, the AP 104 may transmit RAPS information to the STAs 106 that includes a minimum value and a maximum value. The AP 104 may transmit the RAPS information in a discovery frame, in a beacon, in a beacon probe response, among other frames, etc. One or more of the STAs (e.g., the STA 106f) may perform a countdown process based on the values, which will be understood by one having ordinary skill in the art. For example, the STA 106f may initialize a counter (e.g., an OBO counter) to be a random value between zero and the minimum RAPS value. If the STA 106f is unable to successfully connect with the AP 104 based on the selected value (e.g., if there are one or more retries), then, in an example, the STA 106f may then double its value and try again. The station 106f may continue in this manner until successfully connecting with the AP 104. In an aspect, the station 106f may not increase its value beyond the provided RAPS maximum value. In an aspect, the minimum value may be set as 8. Selecting a value (8) can enable a technical advantage of reducing collisions that may otherwise be caused by a very small minimum value. In an aspect, the maximum value may be set as 32. Selecting too large of a value may result in underutilization of the random access resource units. Thus, a value, 8, may be utilized as the minimum value, and a value, 32, may be utilized as the maximum value.

It should be understood that, in accordance with the embodiments described herein, an access point (e.g., the AP 104) may transmit a discovery frame (e.g., the discovery frame 425) including RAPS information. For example, a non-AP STA may know the RAPS for an AP if it hears a beacon from the AP, a probe response, or one or more association and/or re-association frames. Furthermore, in accordance with some embodiments, the non-AP STA may know the RAPS for an AP based on receiving a FILS discovery frame from the AP, as described above.

It should be further understood that, in accordance with other embodiments described herein, an access point (e.g., the AP 104) may transmit a message (e.g., the discovery frame 425) that does not include RAPS information or that does not include a RAPS default value. As described above, if a (e.g., the STA 106f) does not receive a frame from an AP (e.g., the AP 104) including RAPS information, then the STA 106f may select a countdown value based on a default value, e.g., a predefined default value stored at the STA 106f. Thus, the non-AP STA 106f may then utilize the default value when the STA 106f is prepared to send frames to the AP 104 via Random Access. In an aspect, the default RAPS value may be set as 8.

Thus, in accordance with one or more embodiments described herein, a STA (e.g., the STA 106f) may store, in a memory (e.g., the memory 206) of the STA 106f, and in connection with a processor (e.g., the processor 204) of the STA 106f, a default value for a Random Access Parameter Set (RAPS). The STA 106f may perform a RAPS countdown in accordance with the default value. The STA 106f may transmit, in accordance with an assigned at least one resource unit for random access transmissions, a multi-user transmission to the AP 104. In an aspect, the STA 106f may be a non-AP STA.

One having ordinary skill in the art will appreciate that the STAs described herein (e.g., the STA 106e) may or may not support uplink orthogonal frequency division multiple access (OFDMA) based random access (UORA). In one aspect, a STA (e.g., the STA 106e) that does not support uplink orthogonal frequency division multiple access (OFDMA) based random access (UORA) may contend for the wireless medium using Enhanced Distributed Channel Access (EDCA) for sending uplink frames (e.g., a probe request frame) to an AP (e.g., the AP 104) with which the STA 106e intends to communicate.

In accordance with an embodiment, an unassociated STA (e.g., the STA 106f) may determine to transmit one or more frames (e.g., a probe request frame) to an AP that is different from the AP 104 (not pictured), for example, via a random-access resource unit. In this case, the STA 106f may be configured to select a new countdown and/or RAPS value.

Further yet, the AP 104 may generate the discovery frame 425 to indicate a target transmission time for the trigger frame 430. In the case where the trigger frame 430 includes random access RUs, as described in connection with FIG. 4 and FIG. 5, the target transmission time for the trigger frame 430 may be referred to as a TF-RA.

Thus, as illustrated in FIG. 4 and further described in connection with FIG. 5, having received the discovery frame 425 including the indication regarding the upcoming trigger frame 430, receiving STAs (e.g., the STA 106f) may forego wasting resources on passive scanning, active scanning, waiting for another beacon or discovery frame, etc. Instead, such STAs may wait to receive the trigger frame 430 (as informed by the discovery frame 425) to transmit a multi-user transmission for facilitating discovery and/or association (e.g., a probe request) to the AP 104. As an example, the multi-user transmission from one or more of the STAs 106 may comprise a request to associate with the AP 104 in accordance with the assigned at least one resource unit for random access transmissions.

In the alternative, the AP 104 can utilize one or more bits of the discovery frame 425 (e.g., one or more of the reserved bits 640) to indicate that the trigger frame 430 will not assign at least one resource unit for random access transmissions (e.g., during the interval between the current discovery frame and the next discovery frame or beacon frame). In this case, an unassociated station (e.g., the STA 106f) may instead wait for another beacon, another discovery frame, or otherwise attempt to communicate with the AP 104 in single-user (SU) mode.

FIG. 7 is another example message format 700 of a discovery frame (e.g., the discovery frame 425 described in connection with FIG. 4), in accordance with an implementation. In an embodiment, the discovery frame 425 can be a FILS discovery frame, as described above. With respect to the description of FIG. 7 herein, some of the item numbers may refer to the so-numbered aspects described above in connection with one or more of FIGS. 1-6.

The example message format 700 may be similar to the example message format 600 described in connection with FIG. 6, except in this example embodiment, the AP 104 may, or may not, generate the discovery frame 425 to indicate that the trigger frame 430 will assign at least one resource unit for random access transmissions. In either case, in this example embodiment, the AP 104 may extend the discovery frame 425 to include a Random Access Parameter Set (RAPS) information element (IE) 750. In this way, receiving stations may have greater discovery accuracy by utilizing a RAPS value present in the RAPS IE 750, rather than utilizing a default RAPS value, as described in connection with FIG. 6.

The RAPS IE 750 can include one or more aspects, for example, an element ID (e.g., comprising one octet), a length (e.g., comprising one octet), an element ID extension (e.g., comprising one octet), an orthogonal frequency division multiple access (OFDMA) contention window (OCW) range field (e.g., comprising one octet), among other aspects. Furthermore, the OCW range field can include one or more aspects, for example, minimum OCW value, maximum OCW value, and reserved fields and/or bits.

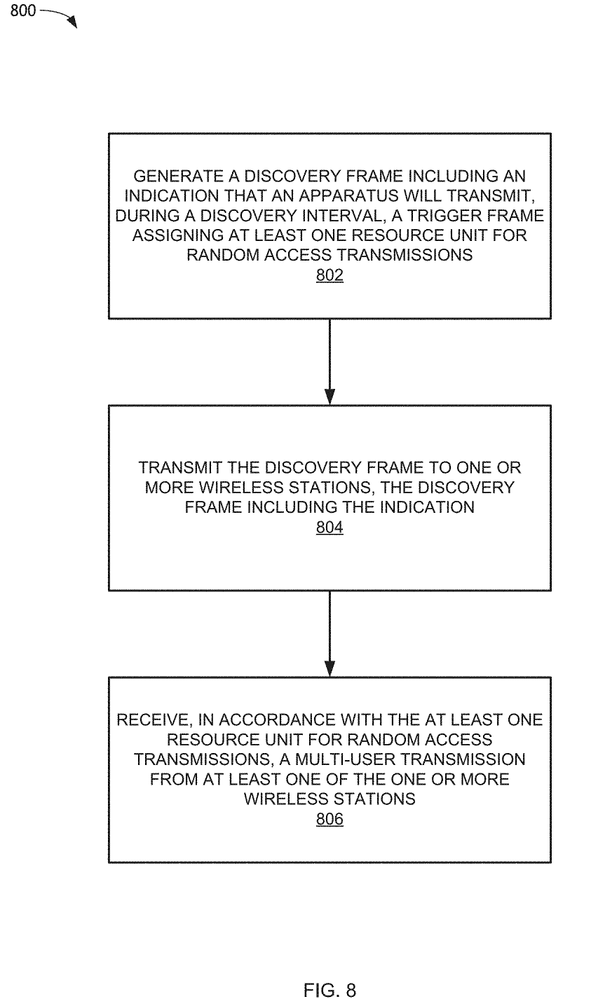

FIG. 8 is a flowchart of a method for wireless communication, in accordance with an implementation. At step 802, the method includes generating a discovery frame (e.g., the discovery frame 425) including an indication that an apparatus (e.g., the AP 104) will transmit, during a discovery interval (e.g., the discovery interval 435), a trigger frame (e.g., the trigger frame 430) assigning at least one resource unit for random access transmissions. At step 804, the method includes transmitting the discovery frame to one or more wireless stations (e.g., the STAs 106), the discovery frame including the indication. At step 806, the method includes receiving, in accordance with the at least one resource unit for random access transmissions, a multi-user transmission from at least one of the one or more wireless stations (e.g., the STA 106f).

In one example, means for generating may comprise the processor 204 of the wireless device 202, which can be, for example, the AP 104. In one example, means for transmitting may comprise the transmitter 210 and/or the transceiver 214 of the wireless device 202, which can be, for example, the AP 104. In one example, means for receiving may comprise the receiver 212 and/or the transceiver 214 of the wireless device 202, which can be, for example, the AP 104. In additional examples, means for defining criteria and/or means for using bits may comprise the processor 204 and/or the memory 206 of the wireless device 202, which can be, for example, the AP 104.

In some aspects, the functions described herein may comprise, in a non-limiting example, a method for wireless communication, comprising: generating, at an apparatus, a discovery frame including an indication that the apparatus will transmit, during a discovery interval, a trigger frame assigning at least one resource unit for random access transmissions; transmitting the discovery frame to one or more wireless stations, the discovery frame including the indication; and receiving, in accordance with the at least one resource unit for random access transmissions, a multi-user transmission from at least one of the one or more wireless stations. In some aspects, the method further comprises generating the discovery frame to include a Random Access Parameter Set (RAPS) information element; and receiving the multi-user transmission in accordance with the RAPS information element. In some aspects, the one or more criteria include a Received Signal Strength Indicator (RSSI), for the one or more wireless stations, being below an RSSI threshold. In some aspects, the method further comprises receiving the multi-user transmission in accordance with an orthogonal frequency division multiple access (OFDMA) backoff value, associated with the at least one of the one or more wireless stations, being decremented only when the at least one of the one or more wireless stations satisfies each of the one or more criteria. In some aspects, the multi-user transmission comprises a request, from the at least one of the one or more wireless stations, to associate with the apparatus in accordance with the at least one resource unit for random access transmissions. In some aspects, the method further comprises generating, at the apparatus, the trigger frame assigning the at least one resource unit for random access transmissions; and during the discovery interval, transmitting the trigger frame to the one or more wireless stations.

In some aspects, the functions described herein may comprise, in a non-limiting example, a non-transitory computer-readable medium comprising code that, when executed, causes a processor of an apparatus to: generate, at the apparatus, a discovery frame including an indication that the apparatus will transmit, during a discovery interval, a trigger frame assigning at least one resource unit for random access transmissions; transmit the discovery frame to one or more wireless stations, the discovery frame including the indication; and receive, in accordance with the at least one resource unit for random access transmissions, a multi-user transmission from at least one of the one or more wireless stations.

In some aspects, the functions described herein may comprise, in a non-limiting example, an apparatus for wireless communication, comprising: a processor, in connection with a memory of the apparatus, configured to: store, in the memory, a default value for a Random Access Parameter Set (RAPS); and perform a RAPS countdown in accordance with the default value; and a transmitter configured to transmit, in accordance with an assigned at least one resource unit for random access transmissions, a multi-user transmission to the access point.

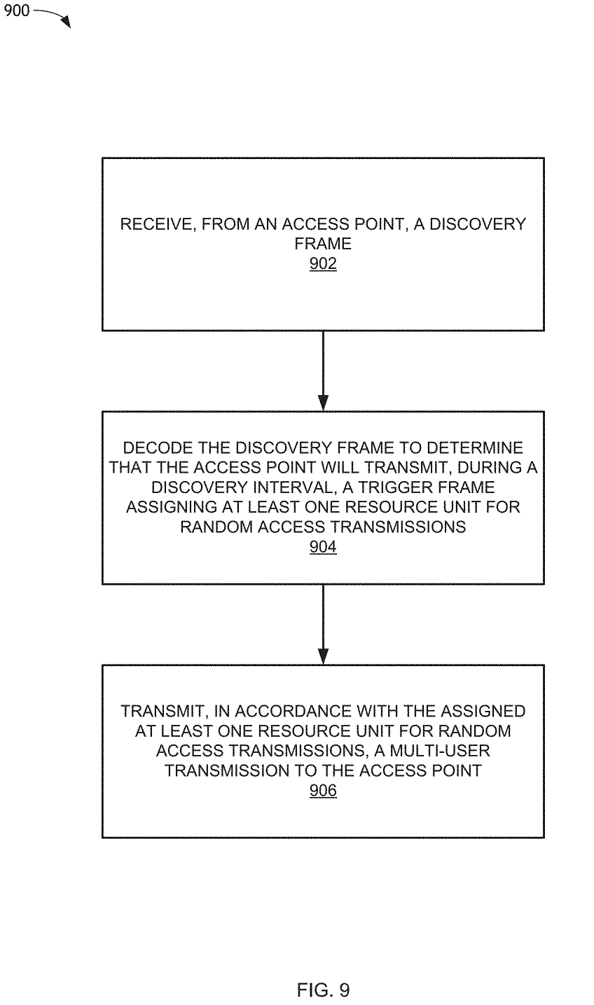

FIG. 9 is a flowchart of a method for wireless communication, in accordance with an implementation. At step 902, the method includes receiving, at an apparatus (e.g., the STA 106f), from an access point (e.g., the AP 104), a discovery frame (e.g., the discovery frame 425). At step 904, the method includes decoding the discovery frame to determine that the access point will transmit, during a discovery interval (e.g., the discovery interval 435), a trigger frame (e.g., the trigger frame 430) assigning at least one resource unit for random access transmissions. At step 906, the method includes transmit, in accordance with the assigned at least one resource unit for random access transmissions, a multi-user transmission to the access point.

In one example, means for means for receiving may comprise the receiver 212 and/or the transceiver 214 of the wireless device 202, which can be, for example, the STA 106f. In one example, means for decoding may comprise the processor 204 of the wireless device 202, which can be, for example, the STA 106f. In one example, means for transmitting may comprise the transmitter 210 and/or the transceiver 214 of the wireless device 202, which can be, for example, the STA 106f. In additional examples, means for processing, generating, decrementing, and/or means for indicating may comprise the processor 204 and/or the memory 206 of the wireless device 202, which can be, for example, the STA 106f.

In some aspects, the functions described herein may comprise, in a non-limiting example, a method for wireless communication, comprising: receiving, from an access point, a discovery frame; decoding the discovery frame to determine that the access point will transmit, during a discovery interval, a trigger frame assigning at least one resource unit for random access transmissions; and transmitting, in accordance with the assigned at least one resource unit for random access transmissions, a multi-user transmission to the access point. In some aspects, the discovery frame includes a Random Access Parameter Set (RAPS) information element, and wherein the method further comprises transmitting the multi-user transmission in accordance with the RAPS information element. In some aspects, the one or more criteria include a Received Signal Strength Indicator (RSSI), for the apparatus, being below an RSSI threshold. In some aspects, the method further comprises: transmitting the multi-user transmission in accordance with an orthogonal frequency division multiple access (OFDMA) backoff value, associated with the apparatus, and decrementing the OFDMA backoff value only when the apparatus satisfies each of the one or more criteria. In some aspects, the multi-user transmission comprises a request, from the apparatus, to associate with the access point in accordance with the at least one resource unit for random access transmissions. In some aspects, the trigger frame assigns the at least one resource unit for random access transmissions, and wherein the method further comprises, during the discovery interval, receiving the trigger frame.

In some aspects, the functions described herein may comprise, in a non-limiting example, a non-transitory computer-readable medium comprising code that, when executed, causes a processor of an apparatus to: receive, from an access point, a discovery frame; decode the discovery frame to determine that the access point will transmit, during a discovery interval, a trigger frame assigning at least one resource unit for random access transmissions; and transmit, in accordance with the assigned at least one resource unit for random access transmissions, a multi-user transmission to the access point.

As used herein, the term “determining” and/or “identifying” encompass a wide variety of actions. For example, “determining” and/or “identifying” may include calculating, computing, processing, deriving, choosing, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, identifying, establishing, selecting, choosing, determining and the like. Further, a “channel width” as used herein may encompass or may also be referred to as a bandwidth in certain aspects.

In the above description, reference numbers may have been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) signal or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an access point 104, a station 106, and/or another device as applicable. For example, such a device can be coupled to a server to facilitate the transfer of means for performing the methods described herein. In some aspects, means for receiving, transmitting, processing, generating, and/or any other means described herein may comprise one or more of the receiver 212, the transceiver 214, the digital signal processor 220, the processor 204, the memory 206, the signal detector 218, the antenna 216, the user interface 222, a WLAN modem, or equivalents thereof. Alternatively, various methods described herein can be provided via storage means (e.g., RAM, ROM, a physical storage medium such as a compact disc (CD) or floppy disk, etc.), such that a wireless device 202, an access point 104, a station 106, and/or another device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

The phrase “based on” does not mean “based only on,” unless expressly specified otherwise. In other words, the phrase “based on” describes both “based only on” and “based at least on.”

While the foregoing is directed to aspects of the present disclosure, other and further aspects of the disclosure may be devised without departing from the basic scope thereof, and the scope thereof is determined by the claims that follow.

What is claimed is:

1. An apparatus for wireless communication, comprising:
a processor configured to generate, at the apparatus, a discovery frame including an indication that the apparatus will transmit, during a discovery interval, a trigger frame assigning at least one resource unit for random access transmissions;
a transmitter configured to transmit the discovery frame to one or more wireless stations, the discovery frame including the indication; and
a receiver configured to receive, in accordance with the at least one resource unit for random access transmissions, a multi-user transmission from at least one of the one or more wireless stations.

2. The apparatus of claim 1, the method further comprising generating the discovery frame to include the indication in at least one of: one or more reserved bits of the discovery frame, a field of the discovery frame, and an element of the discovery frame.

3. The apparatus of claim 1, wherein:
the processor is further configured to generate the discovery frame to include a Random Access Parameter Set (RAPS) information element; and
the receiver is further configured to receive the multi-user transmission in accordance with the RAPS information element.

4. The apparatus of claim 1, wherein the trigger frame includes a user information field including an association identifier (AID) subfield, and wherein the processor is further configured to generate the trigger frame to indicate, using one or more bits of the AID subfield, that the assignment of the at least one resource unit for random access transmissions is reserved for unassociated wireless stations.

5. The apparatus of claim 1, wherein the trigger frame includes a user information field including an association identifier (AID) subfield, and wherein the processor is further configured to:
define one or more criteria that the one or more wireless stations must satisfy to qualify for random access priority in association with the at least one resource unit for random access transmissions; and
using one or more bits of the AID subfield, indicate that the at least one resource unit for random access transmissions is reserved for unassociated wireless stations that satisfy the one or more criteria.

6. The apparatus of claim 5, wherein the one or more criteria include a Received Signal Strength Indicator (RSSI), for the one or more wireless stations, being below an RSSI threshold.

7. The apparatus of claim 5, wherein the receiver is further configured to receive the multi-user transmission in accordance with an orthogonal frequency division multiple access (OFDMA) backoff value, associated with the at least one of the one or more wireless stations, being decremented only when the at least one of the one or more wireless stations satisfies each of the one or more criteria.

8. The apparatus of claim 1, wherein the multi-user transmission comprises a request, from the at least one of the one or more wireless stations, to associate with the apparatus in accordance with the at least one resource unit for random access transmissions.

9. The apparatus of claim 1, wherein the discovery frame comprises a Fast Initial Link Setup (FILS) discovery frame, and wherein the processor is further configured to generate the discovery frame to indicate a target transmission time for the trigger frame.

10. The apparatus of claim 1, wherein:
the processor is further configured to generate, at the apparatus, the trigger frame assigning the at least one resource unit for random access transmissions; and
the transmitter is further configured to, during the discovery interval, transmit the trigger frame to the one or more wireless stations.

11. An apparatus for wireless communication, comprising:
a receiver configured to receive, from an access point, a discovery frame;
a processor configured to decode an indication included in the discovery frame to determine that the access point will transmit, during a discovery interval, a trigger frame assigning at least one resource unit for random access transmissions; and
a transmitter configured to transmit, in accordance with the assigned at least one resource unit for random access transmissions, a multi-user transmission to the access point.

12. The apparatus of claim 11, wherein the indication is included in at least one of: one or more reserved bits of the discovery frame, a field of the discovery frame, and an element of the discovery frame.

13. The apparatus of claim 11, wherein the discovery frame includes a Random Access Parameter Set (RAPS) information element, and wherein the transmitter is further configured to transmit the multi-user transmission in accordance with the RAPS information element.

14. The apparatus of claim 11, wherein the trigger frame includes a user information field including an association identifier (AID) subfield, and wherein the trigger frame indicates, using one or more bits of the AID subfield, that the assignment of the at least one resource unit for random access transmissions is reserved for unassociated wireless stations.

15. The apparatus of claim 11, wherein the trigger frame includes a user information field including an association identifier (AID) subfield, and wherein one or more of the trigger frame and the discovery frame defines one or more criteria that the apparatus must satisfy to qualify for random access priority in association with the at least one resource unit for random access transmissions, and that using one or more bits of the AID subfield, the apparatus indicates that the at least one resource unit for random access transmissions is reserved for unassociated wireless stations that satisfy the one or more criteria.

16. The apparatus of claim 15, wherein the one or more criteria include a Received Signal Strength Indicator (RSSI), for the apparatus, being below an RSSI threshold.

17. The apparatus of claim 15, wherein the transmitter is further configured to transmit the multi-user transmission in accordance with an orthogonal frequency division multiple access (OFDMA) backoff value, associated with the apparatus, and wherein the apparatus decrements the OFDMA backoff value only when the apparatus satisfies each of the one or more criteria.

18. The apparatus of claim 11, wherein the multi-user transmission comprises a request, from the apparatus, to associate with the access point in accordance with the at least one resource unit for random access transmissions.

19. The apparatus of claim 11, wherein the discovery frame comprises a Fast Initial Link Setup (FILS) discovery frame, and wherein the discovery frame indicates a target transmission time for the trigger frame.

20. The apparatus of claim 11, wherein the trigger frame assigns the at least one resource unit for random access transmissions, and wherein the receiver is further configured to, during the discovery interval, receive the trigger frame.

21. A method for wireless communication, comprising:
generating, at an apparatus, a discovery frame including an indication that the apparatus will transmit, during a discovery interval, a trigger frame assigning at least one resource unit for random access transmissions;
transmitting the discovery frame to one or more wireless stations, the discovery frame including the indication; and
receiving, in accordance with the at least one resource unit for random access transmissions, a multi-user transmission from at least one of the one or more wireless stations.

22. The method of claim 21, the method further comprising generating the discovery frame to include the indication in at least one of: one or more reserved bits of the discovery frame, a field of the discovery frame, and an element of the discovery frame.

23. The method of claim 21, wherein the trigger frame includes a user information field including an association identifier (AID) subfield, and wherein the method further comprises generating the trigger frame to indicate, using one or more bits of the AID subfield, that the assignment of the at least one resource unit for random access transmissions is reserved for unassociated wireless stations.

24. The method of claim 21, wherein the trigger frame includes a user information field including an association identifier (AID) subfield, and wherein the method further comprises:
defining one or more criteria that the one or more wireless stations must satisfy to qualify for random access priority in association with the at least one resource unit for random access transmissions; and
using one or more bits of the AID subfield, indicating that the at least one resource unit for random access transmissions is reserved for unassociated wireless stations that satisfy the one or more criteria.

25. The method of claim 21, wherein the discovery frame comprises a Fast Initial Link Setup (FILS) discovery frame, and wherein the method further comprises generating the discovery frame to indicate a target transmission time for the trigger frame.

26. A method for wireless communication, comprising:
receiving, from an access point, a discovery frame;
decoding an indication included in the discovery frame to determine that the access point will transmit, during a discovery interval, a trigger frame assigning at least one resource unit for random access transmissions; and
transmitting, in accordance with the assigned at least one resource unit for random access transmissions, a multi-user transmission to the access point.

27. The method of claim 26, wherein the indication is included in at least one of: one or more reserved bits of the discovery frame, a field of the discovery frame, and an element of the discovery frame.

28. The method of claim 26, wherein the trigger frame includes a user information field including an association identifier (AID) subfield, and wherein the trigger frame indicates, using one or more bits of the AID subfield, that the assignment of the at least one resource unit for random access transmissions is reserved for unassociated wireless stations.

29. The method of claim 26, wherein the trigger frame includes a user information field including an association identifier (AID) subfield, and wherein one or more of the trigger frame and the discovery frame defines one or more criteria that the apparatus must satisfy to qualify for random access priority in association with the at least one resource unit for random access transmissions, and that using one or more bits of the AID subfield, the apparatus indicates that the at least one resource unit for random access transmissions is reserved for unassociated wireless stations that satisfy the one or more criteria.

30. The method of claim 26, wherein the discovery frame comprises a Fast Initial Link Setup (FILS) discovery frame, and wherein the discovery frame indicates a target transmission time for the trigger frame.
